(19) United States
(12) Patent Application Publication
(10) Pub. No.: US 2008/0208764 A1
(43) Pub. Date: Aug. 28, 2008

(54) Defined Fixed Percentage Rate Distribution Schedule For Open End Mutual Funds

(75) Inventor: Keith Bayley Diffenderffer, Chula Vista, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Keith Bayley Diffenderffer, Chula Vista, CA (US)

(21) Appl. No.: 11/679,144

(22) Filed: Feb. 26, 2007

(51) Int. Cl. G06Q 40/00

(52) U.S. Cl. 705/36 R

(57) ABSTRACT

The Defined Fixed Rate Distribution Schedule standardizes by prospectus the rate of distributed income for a specific mutual fund. This will allow shareholders the ability to assess future income potential as well as risk and reward.

Defined Fixed Percentage Rate Distribution Schedules will specify by Prospectus the distribution requirements for an individual Mutual Fund.

The Fund will collect from its equity and debt investments income from interest payments, dividends, rents, royalties, premiums, short term capital gains, long term capital gain and return of capital; but make distributions of income on a quarterly schedule at a fixed percentage of Per Share Net Asset Value. An annual supplemental distribution is established to ensure compliance with Investment Company Act of 1940 Rule 19, Rule 19a-1 and Rule 19b-1. The Defined Fixed Rate Distribution Schedule integrates with the asset allocation investment process of the Fund Management Team to enhance shareholder value.

What is claimed is:

1. The Defined Fixed Rate Distribution Schedule will enhance mutual fund shareholder value by providing the income-oriented investor who has specific annual cash flow requirements the ability to invest in a professionally managed investment portfolio utilizing the benefits of Modern Portfolio Theory. The current standard in the industry separates income requirements from portfolio optimization. The investor is forced to select Funds that provide either the yield they need; but not the diversification or the diversification they need; but not the yield or combine two or more funds together and create the required income through an arbitrary combination of fund distributions and systematic liquidation independent of fund objectives. The investor should then on a rational basis, during sometimes turbulent markets, make periodic adjustments for changes in interest rates, yield curve, credit quality, equity valuation, economic, political and market risk. The Defined Fixed Rate Distribution Schedule represents a significant improvement to the current Mutual Fund Industry Model because it allows the investor to choose both an asset allocation model and satisfy a specific percentage income requirement within the same professionally managed mutual fund.
